(19) United States
(12) Patent Application Publication
(10) Pub. No.: US 2026/0355884 A1
(43) Pub. Date: Nov. 12, 2026

(54) MACHINING CENTER

(71) Applicant: AFW Holding GmbH, Kirchham (AT)

(72) Inventor: Dominik WEINGÄRTNER, Kirchham (AT)

(21) Appl. No.: 19/133,024

(22) PCT Filed: Nov. 15, 2023
(86) PCT No.: PCT/EP2023/081848

§ 371 Date: May 27, 2025

(30) Foreign Application Priority Data
Nov. 28, 2022 (EP) 22209821.2

(51) Int. Cl. B23Q 7/04

(52) U.S. Cl. CPC B23Q 7/04; B23Q 2707/003

(57) ABSTRACT

A machining center for machining a workpiece includes a machining unit arranged in a machining area of the machining center and a machining tool for machining a workpiece relative to a machining axis. The machining center includes a transport vehicle with a holding device for receiving at least two workpieces. The transport vehicle is movably mounted in a translational degree of freedom of movement at least between a first position within the machining center and a second position outside the machining center, wherein the transport vehicle and/or the holding device is mounted movably in a rotational degree of freedom of movement.

The invention relates to a machining centre for machining a workpiece, wherein the machining centre comprises of a machining unit which is arranged in a machining area and which comprises a workpiece machining unit for machining a workpiece.

Corresponding machining centers for machining a workpiece are known from the state of the art and can, for example, be designed as turning and/or milling centers and thus enable, for example, turning and/or milling of a workpiece.

With regard to an efficient production process of a machined workpiece, the fastest possible transport of a workpiece to be machined into the machining area of a respective machining centre or the fastest possible transport of a machined workpiece from the machining area of a respective machining centre is important.

In the state of the art, solutions have already been proposed to convey a workpiece to be machined via transport units into the machining area of a respective machining centre or to convey a workpiece machined from the machining area of a respective machining centre.

However, the solutions known from the state of the art are in need of improvement or further development with regard to aspects such as efficiency, practicability and reliability.

Based on this, the object of the present invention is to provide an improved machining centre for machining a workpiece.

The object is achieved by a machining centre for machining a workpiece according to independent claim 1. The dependent claims relate to possible embodiments of the machining centre.

A first aspect of the invention relates to a machining centre for machining a workpiece. The machining centre is therefore set up for machining a workpiece. A metal-cutting machining of a workpiece can be understood to mean, in particular, a drilling machining and/or a turning machining and/or a milling machining of a workpiece. The machining centre may thus be configured as or comprise a drilling centre, a turning centre, or a milling centre, or a combined drilling and/or turning and/or milling centre.

The workpiece or a workpiece that can be machined by means of the machining centre is typically a metallic workpiece. A metallic workpiece may be, for example, a workpiece made of an iron-based metallic material. The workpiece that can be machined by means of the machining centre can have a rotationally symmetrical shape or basic shape. The workpiece can thus be, for example, at least partially, optionally completely, disk-shaped, annular disk-shaped, cylindrical or hollow cylindrical.

The machining centre comprises a machining area in which the machining of the workpiece takes place. The machining chamber, which may also be referred to as a machining area, typically also contains a machine bed or machine frame of the machining centre.

The machining area can be delimited or defined by a housing structure of the machining centre. The housing structure may be formed by or comprise one or more housing structure elements. The housing structural elements can form walls that delimit the machining area. At least one housing structure element can be mounted movably relative to at least one other housing structure element in a degree of freedom of movement, i.e. e.g. in a sliding and/or pivoting degree of freedom of movement, in order to be moved into at least one open position, in which an access possibility into the machining area is provided, and/or in order to be moved into at least one closed position, in which no access possibility into the machining area is provided.

At least one machining unit is arranged in the machining area, which comprises a machining tool for machining a workpiece. The machining tool may be, for example, a drilling tool and/or a turning tool and/or a milling tool. Consequently, the at least one machining unit can be designed as or comprise a drilling unit, a turning unit or a milling unit or a combined drilling and/or turning and/or milling unit. Depending on the specific embodiment, the machining unit and/or the machining tool can be mounted movably in at least one translational and/or rotational degree of freedom of movement, e.g. relative to a horizontal and/or vertical spatial axis, e.g. in order to be able to machine a workpiece to be machined on different sections and/or in different orientations. The machining centre can thus enable complete machining of a workpiece to be machined.

The machining tool is configured, in particular, to machine a workpiece to be machined in at least one machining axis or relative to at least one machining axis. For a workpiece that has a rotational axis or a central axis and is to be machined, it is typically the case that it is typically arranged coaxially with respect to the at least one machining axis or parallel to the at least one machining axis during machining by means of the machining unit. The at least one machining axis may be a horizontally aligned axis. In particular, the at least one machining axis can be an axis oriented parallel to a longitudinal axis of the machine bed or machine frame. For a workpiece that has a rotational axis or a central axis and is to be machined, it is typically the case that it is typically arranged coaxially with respect to the at least one machining axis or parallel to it during machining by means of the machining unit.

As can be seen below, the machine bed or machine frame can optionally be elongated, so that it extends not only inside the machining area, but also outside the machining area. In particular, the machine bed or machine frame can optionally extend into an area outside a housing structure of the machining centre, so that the machine bed or machine frame has sections both inside and outside the housing structure of the machining centre.

The machining centre further comprises at least one transport vehicle. The transport vehicle is designed with or comprises a holding device for receiving at least two workpieces. The transport vehicle can thus comprise a base(body)structure, e.g. in the form of a chassis or a chassis, on which the holding device for receiving at least two workpieces is arranged or formed.

The holding device is therefore basically configured to receive at least two workpieces, which may be unmachined workpieces and/or workpieces machined at least in sections. However, this does not mean that the holding device always necessarily receives at least two workpieces during operation of the machining centre; the holding device is only configured for this purpose in principle.

A holding fixture of a respective workpiece by means of the holding fixture can be understood to be a direct or indirect holding fixture of the respective workpiece. Corresponding active sections of the holding device configured to receive at least one workpiece can thus act directly or indirectly on a respective workpiece in order to hold the respective workpiece directly or indirectly. The holding device can thus be configured to receive at least one workpiece directly; the respective workpiece can thus be received by means of the holding device need for an intermediate fixture system supporting the workpiece, such as a clamping or tensioning system. Corresponding active sections of the holding device can engage the workpiece here in order to receive it. Alternatively or additionally, the holding device can be configured to receive at least one workpiece indirectly, and the respective workpiece can therefore be received by means of the holding device with the interposition of a device system that supports the workpiece, such as a clamping or tensioning system. Corresponding operative portions of the holding device can engage the device system here in order to receive it. A corresponding device system may, for example, be designed as or comprise a chuck, in particular a power chuck, or a zero-point clamping system.

A holding of a respective workpiece by means of the holding device typically includes a workpiece to be machined being received or held by means of the holding device in such a way that it can be transferred from the holding device to a clamping system of the machining centre or taken over by the latter within the machining area. Similarly, holding the respective workpiece to be machined or machined by means of the holding device typically means that a machined workpiece can be received or held by means of the holding device in such a way that it can be transferred from a clamping system of the machining centre to the holding device or taken over by the latter within the machining area.

In principle, it is also conceivable that a workpiece picked up by means of the pick-up device can be machined as intended by means of the machining unit within the machining area; in this case, the workpiece does not have to be transferred to or taken over by a clamping system of the machining centre.

The holding device is thus configured to receive or hold a respective workpiece in a specific orientation and/or position. In particular, the holding device can be configured to receive or hold a respective workpiece in an orientation and/or position that corresponds to an orientation and/or position in which the workpiece can be transferred to a clamping system of the machining centre, or in which the workpiece can be machined or machined by means of the machining unit. Consequently, the holding device can be specifically configured, for example, to receive or hold a respective workpiece in an orientation and/or position in which a rotational or central axis of the workpiece is arranged coaxially with respect to the machining axis or parallel to the machining axis. Receiving a workpiece in such an orientation and/or position can enable the workpiece to be transferred to a clamping system of the machining centre or a machining of the workpiece by means of the machining unit.

The transport vehicle, together with the holding device, is movably mounted in a translational degree of freedom of movement at least between at least a first position within the machining centre, in particular within the machining area, and at least a second position outside the machining centre. The transport vehicle can thus be moved translationally along a movement axis into at least a first position within the machining centre, in particular within the machining area, and into at least a second position outside the machining centre. The movement axis of the transport vehicle can be arranged or aligned, for example, coaxially with respect to the machining axis or parallel to the machining axis.

The at least one first position may correspond to a transfer position or a machining position of at least one workpiece received by means of the holding device. At least one workpiece received by means of the holding device can therefore be arranged or aligned within the machining area in the at least one first position in such a way that it is in a transfer position in which it can be transferred to a clamping system of the machining centre (the machining of the workpiece by means of the machining unit or the machining tool is therefore carried out in the clamped state by means of the clamping system). Alternatively, at least one workpiece received by means of the holding device can be arranged or aligned in the at least one first position within the machining area in such a way that it is located in a machining position in which it can be machined by means of the machining unit or the machining tool.

If the machining centre comprises a housing structure, the at least one first position is therefore typically located within the housing structure of the machining centre, whereas the at least one second position is typically located outside the housing structure of the machining centre. If the machining centre comprises a housing structure with a housing structure element movably supported between an open and a closed position, as explained, it may be necessary to move the movably supported housing structure element to the open position in order to move the transport vehicle from the first position to the second position or vice versa.

Due to the possibility that the transport vehicle can be moved into at least one corresponding second position outside the machining centre, i.e. in particular outside the machining area, both a particularly efficient pick-up or loading of at least one workpiece to be machined onto the pick-up device and a particularly efficient removal or unloading of at least one workpiece machined from the pick-up device can be realized outside the machining centre, i.e. in particular outside the machining area. Corresponding pick-up or loading as well as corresponding removal or unloading operations can be carried out by means of a handling device that can be assigned or is assigned to the machining centre, such as a handling robot.

The fact that the transport vehicle and/or the holding device is mounted movably in a rotational degree of freedom of movement contributes to a particularly efficient removal or unloading of workpieces. The transport vehicle and/or the holding device are therefore mounted so as to be movable individually or together in a rotational degree of freedom of movement. By means of corresponding rotational or rotational movements of the transport vehicle and/or the holding device in the rotational degree of freedom of movement, receiving or removal processes of workpieces can be carried out even more efficiently by means of the holding device, in particular because a workpiece to be received on one side of the holding device and to be machined can be moved by corresponding rotation of the transport vehicle and/or the holding device into an orientation and/or position in which it can be machined after moving the transport vehicle into the first position, i.e. in particular into a corresponding transfer or machining position, and/or because a workpiece received on another side of the holding device and already machined can be moved by corresponding rotation of the transport vehicle and/or the holding device into an orientation and/or position in which it can be removed from the holding device after moving the transport vehicle into the second position, e.g. by means of a handling device, such as a handling robot. In principle, by appropriately rotating the transport vehicle and/or the holding device in the rotational degree of freedom of movement, each receiving region of the holding device can be brought into an orientation in which it is arranged opposite a workpiece holding device, i.e., e.g., a clamping system, of the machining centre. Based on this, a workpiece received or held on the receiving region of the holding device can be moved into a corresponding transfer or processing position by moving the transport vehicle into the first position.

The movements of the transport vehicle and/or the holding device in the at least one rotational degree of freedom of movement take place about a rotational or rotational axis. The axis of rotation can be an axis oriented at an angle, i.e. in particular at a right angle, to the processing axis and thus at an angle or at a right angle to the movement axis of the transport vehicle.

With regard to the rotational degree of freedom of movement of the holding device, this typically allows rotational movements of the holding device relative to the transport vehicle, i.e. in particular relative to the aforementioned basic(body)structure, e.g. in the form of a chassis or a chassis, of the transport vehicle. The holding device can therefore be moved relative to the base(body)structure and in principle independently thereof in the at least one rotational degree of freedom of movement. For this purpose, the transport vehicle, i.e. in particular the base(body)structure, can comprise one or more rotary bearings, via which the holding device is mounted rotatable relative to the base(body)structure.

Overall, there is an improved machining centre for machining a workpiece.

The holding device can have at least two receiving regions for at least one workpiece in each case, wherein at least one receiving region is typically arranged and/or aligned in such a way that a workpiece can be received or received in such a way that it can be moved into a corresponding transfer or processing position when the transport vehicle is moved into the at least one first position. Each receiving region can have or define at least one plane or surface on which at least one workpiece can be received and thus, as mentioned, held stably.

The at least two receiving regions of the holding device are typically arranged or formed on different sides of the holding device; in particular, the at least two receiving regions can be arranged or formed on opposite sides of the holding device. If the holding device has more than two receiving regions, these may also be arranged or formed on different sides of the holding device. For a conceivable embodiment with three receiving regions, the planes or surfaces defined by the respective receiving regions can each be arranged at an angle of 120° relative to one another. For an equally conceivable embodiment with four receiving regions, the planes or surfaces defined by the respective receiving regions can each be arranged at an angle of 90° relative to one another. In principle, it can therefore be said that planes or surfaces n (n is a whole number) defined by the respective recording regions can each be arranged at an angle α=360°/n relative to one another.

It has been mentioned that by corresponding rotation of the transport vehicle and/or the holding device in the at least one rotational degree of freedom of movement, each receiving region can in principle be brought into an orientation in which it is arranged opposite a workpiece holding device, i.e. in particular a stationary workpiece holding device, such as a clamping system, of the machining centre. The transport vehicle and/or the holding device can thus be movably mounted in the rotational degree of freedom of movement into a first position in which a first workpiece, which is received by means of the holding device and can be received in a first receiving region of the holding device, is arranged or aligned opposite a workpiece holding device of the machining centre. Alternatively or additionally, the transport vehicle and/or the holding device can be movably mounted in the rotational degree of freedom of movement into a second position, in which a second workpiece, which is received by means of the holding device and can be received in a second receiving region of the holding device, is arranged or aligned opposite the workpiece holding device of the machining centre.

The first position of the transport vehicle and/or the holding device can be a position rotated by 180° with respect to the or a vertical axis of rotation relative to the second position and vice versa; this applies in particular to configurations of the holding device with two receiving regions arranged or formed opposite one another.

The holding device can have a receiving frame, in particular a cage-like or basket-like receiving frame, or a receiving frame, in particular a cage-like or basket-like receiving frame. The receiving frame or the receiving frame can be formed by one or more frame or frame elements, which are connected to one another in one or more spatial directions or spatial planes, forming the receiving frame or receiving frame. Corresponding receiving regions for workpieces can be arranged or formed on the receiving frame or the receiving frame.

As mentioned above, the holding device can in principle be configured to hold a workpiece indirectly or directly. Accordingly, at least one first holding device for holding a first workpiece or for holding a device system that supports a first workpiece, in particular a clamping or tensioning system, and at least one second holding device for holding a second workpiece or for holding a device system that supports a second workpiece, in particular a clamping or tensioning system, can be arranged or configured on the receiving frame or the receiving frame.

The first holding device can have one or more first holding elements, which can be transferred into at least one holding position, in which a holding force holding a first workpiece or a first workpiece-bearing device system is formed, and into at least one non-holding position, in which no holding force holding a first workpiece or a first workpiece-bearing device system is formed. The respective first holding elements can thus be movably arranged or formed on the receiving frame or the receiving frame. The first holding device may be associated with a first receiving region of the holding device. Alternatively or additionally, the second holding device can have one or more second holding elements, which can be transferred into at least one holding position, in which a holding force holding a second workpiece or a second workpiece-bearing device system is formed, and into at least one non-holding position, in which no holding force holding a second workpiece or a second workpiece-bearing device system is formed. Respective second mounting elements can thus be movably arranged or formed on the receiving frame of the receiving space. The second holding device may be associated with a second receiving region of the holding device. If the holding device comprises more than two receiving regions, more than two correspondingly configured holding devices may be provided.

The one or more first holding elements can be designed, for example, as clamping or clamping jaws, in particular as clamping or clamping jaws acting axially and/or radially with respect to the machining axis or a central axis of the respective workpiece in the respective holding position. In this way, a stable mounting of a respective workpiece can be realized.

Alternatively or additionally, the one or more second holding elements can be designed as clamping or clamping jaws, in particular as clamping or clamping jaws acting axially and/or radially with respect to the machining axis or a central axis of the respective workpiece in the respective holding position. In this way, a stable mounting of a respective workpiece can be realized.

The first and/or second holding elements can therefore be the above-mentioned active sections of the holding device.

The one or more first holding elements and/or the one or more second holding elements may be arranged or formed uniformly or unevenly distributed in the circumferential direction with respect to the machining axis or a central axis of the respective workpiece, for example.

In order to set the transport vehicle and/or the holding device in corresponding translational and/or rotational movements, the processing centre may comprise a provision device for providing energy for generating at least one driving force that sets the transport vehicle and/or the holding device in translational and/or rotational movements. In this case, the drive force that sets the transport vehicle and/or the holding device into corresponding translational and/or rotational movements can be generated by a drive medium provided to a, e.g. motorized, drive unit of the transport vehicle and/or the holding device via the providing device. The drive medium may be an energy carrier, e.g. in the form of electrical energy, hydraulic energy or pneumatic energy. The drive unit of the transport vehicle and/or of the holding device can therefore be embodied, for example, as an electrical, electromechanical, hydraulic or pneumatic drive unit or comprise such a drive unit.

The energy carrier provided via the provision device can be provided or can be provided via an output of the provision device communicating with an input of the transport vehicle and/or the holding device. The supply device can therefore have an output, e.g. in the form of an output connection for a respective energy carrier, via which an energy carrier can be discharged from the machining centre. Accordingly, the transport vehicle and/or the holding device can have an input, e.g. in the form of an input connection for a respective energy carrier, via which the energy carrier can be supplied to the transport vehicle and/or the holding device. A corresponding output and a corresponding input can be connected to one another via line connections or supply lines, such as cables, hoses, pipes, etc. Corresponding line connections or supply lines can be accommodated in a carrier provided for this purpose, such as a trailing cable, an energy guiding chain, a cable route, etc. Data cables, for example for transmitting control information, can also be accommodated in a corresponding carrier.

The energy for setting the transport vehicle and/or the holding device into corresponding translational and/or rotational movements can therefore be provided via a provision device of the machining centre; the transport vehicle and/or the holding device therefore does not have to have its own energy supply, which is thus independent of the machining centre, as the energy supply that is required or given in any case for the operation of the machining centre can also be used for the energy supply of the transport vehicle and/or the holding device. In particular, the energy supply required in any case for the operation of the machining centre can be used to generate corresponding drive forces, via which the transport vehicle and/or the holding device can be set into corresponding translational and/or rotational movements. Corresponding drive forces can specifically be generated, for example, via motorized drive units of the transport vehicle and/or the holding device, which are or will be operated with the energy carriers provided by the providing device.

In an analogous manner, the energy required for the movements of mounting elements into respective mounting positions and non-mounting positions, and thus the energy supply to respective mounting devices, can take place via the energy supply that is required or given anyway for the operation of the machining centre.

The concrete movable storage of the transport vehicle can be realized via various storage devices or elements. The transport vehicle can therefore be designed as or comprise a carriage or trolley guided via at least one bearing element, in particular a sliding, ball or roller bearing element, on a transport track, in particular a rail. In principle, linear drives or units, such as, for example, sliding drives or units, spindle drives or units, rack and pinion drives or units, etc., are suitable for movably mounting the transport vehicle in the translational degree of freedom of movement.

The transport track can thus define the translational degree of freedom of movement in which the transport vehicle, as described, is movably mounted in the at least one first and in the at least one second position. Both on the part of the transport vehicle and on the part of the transport track, which, as mentioned, can be formed by the machine bed or machine frame of the machining centre, cooperating guide elements can be present, e.g. in a form-fitting manner, which enable a stably guided movement of the transport vehicle in the translational degree of freedom of movement. At least in sections, the transport track may be integrated into the machine bed or machine frame of the machining centre, which may be extended, as explained above, in areas outside a housing structure of the machining centre.

It has been mentioned that workpieces can be picked up on the pick-up device and/or removed from the pick-up device by means of handling devices. The machining centre can therefore comprise at least one handling device, in particular implemented by an industrial robot or comprising such a handling device, which is configured for loading the transport vehicle, in particular the transport vehicle moved into a loading position outside the machining centre, with at least one workpiece and/or for unloading at least one workpiece from the transport vehicle, in particular from the transport vehicle moved into an unloading position outside the machining centre.

The at least one handling device can be configured, in particular, for transferring a workpiece, in particular a workpiece that has not yet been machined or a workpiece that has been machined at least in sections, from the machining centre to a process station, such as a set-up station or a conversion station, and/or to a further machining centre.

The machining centre can comprise a hardware-and/or software-implemented control device, which is configured to control the operation of the machining centre. In particular, the control device is configured to control corresponding movements of the transport vehicle and/or the holding device as well as corresponding movements of the holding device elements in a coordinated manner in order to enable, in particular in an automated or automated manner, e.g. a proper loading of the holding device with at least one workpiece to be machined, a proper transfer of a workpiece to be machined from the holding device, e.g. to a clamping system of the machining centre, a proper machining of at least one workpiece by means of the machining unit, a proper transfer of a workpiece machined to the holding device, and a proper unloading of at least one workpiece machined from the holding device.

A second aspect of the invention therefore relates to a machining arrangement for machining a workpiece. The machining arrangement comprises at least one first machining centre according to the first aspect of the invention, at least one process station, such as a set-up station or a conversion station, and/or at least one further machining centre, and at least one handling device. The at least one handling device is configured in particular for transferring a workpiece, in particular a workpiece that has not yet been machined or a workpiece that has been machined at least in sections, from the at least one first machining centre to the at least one process station and/or to the at least one further machining centre, or vice versa.

All statements in connection with the machining centre according to the first aspect of the invention apply analogously to the machining arrangement according to the second aspect of the invention.

The processing arrangement can be configured in various ways with regard to the arrangement of the units associated therewith, i.e. the at least one first processing centre, the at least one process station and/or the at least one further processing centre. For example, the at least one first processing centre and the at least one process station and/or the at least one further processing centre may be connected in series or at an angle to one another, in particular parallel to one another. If the machining arrangement comprises a plurality of machining centres, the at least one handling device can be arranged between them, e.g. to enable a transfer of a workpiece from one machining centre to another machining centre.

A third aspect of the invention relates to a method for operating at least one machining centre according to the first aspect of the invention. The method comprises at least the following steps: Moving the transport vehicle, which has received at least one workpiece to be machined, into a position within the machining area of a machining centre (first position), in particular into a corresponding transfer or machining position, and moving the transport vehicle, which has received at least one workpiece machined in the machining area of the machining centre, into a position outside the machining area (second position).

The method may further comprise a step of moving the transport vehicle or the holding device in the rotational degree of freedom of movement outside or inside the processing space. In this way, for example, loading and unloading processes of the holding device can be realized with at least one workpiece. For this purpose, a corresponding handling device can be used, which is configured to grip the respective workpiece directly or indirectly.

In a specific embodiment, the method may comprise the following steps:
moving the transport vehicle, which has received at least one workpiece to be machined, into a position, in particular into a transfer or machining position, in which machining of the workpiece by means of the machining unit is possible, within the machining area,
transferring the at least one workpiece from the holding device to a clamping system of the machining centre,
machining the at least one workpiece clamped by means of the clamping system within the machining area by means of the machining unit,
transferring the at least one machined workpiece from the clamping system of the machining centre to the holding device,
moving the transport vehicle that has received the at least one machined workpiece to a position outside the machining centre,
unloading the at least one machined workpiece from the transport vehicle.

The method may further comprise the steps of:
rotating the transport vehicle and/or the holding device in the rotational degree of freedom of movement,
loading the pick-up device with a second workpiece to be machined,
moving the transport vehicle, which has received the second workpiece to be machined, into a position within the machining area, in particular into a transfer or machining position, in which machining of the second workpiece by means of the machining unit is possible,
transferring the at least one second workpiece to be machined from the holding device to a clamping system of the machining centre,
machining the at least one second workpiece clamped by means of the clamping system within the machining area by means of the machining unit,
transferring the at least one second machined workpiece from the clamping system of the machining centre to the holding device,
moving the transport vehicle that has received the at least one second machined workpiece to a position outside the machining centre,
unloading the at least one second machined workpiece from the transport vehicle.

In a further specific embodiment, the method may comprise the following steps:
moving the transport vehicle, which has received two workpieces to be machined mechanically, into a position, in particular into a transfer or machining position, in which machining of a first workpiece by means of the machining unit is possible, within the machining area,
transferring the first workpiece to be machined from the holding device to a clamping system of the machining centre in the machining area,
machining the first workpiece clamped by means of the clamping system by means of the machining unit,
transferring the first machined workpiece from the clamping system of the machining centre to the holding device,
moving the transport vehicle, which has picked up the first machined workpiece and the second (still unmachined) workpiece, to a position outside the machining centre,
unloading the first machined workpiece from the transport vehicle,
if necessary, loading the holding device with a third workpiece to be machined at a free receiving region of the holding device, e.g. at which the first workpiece was previously received,
rotating the transport vehicle and/or the holding device in the rotational degree of freedom of movement in such a way that the second workpiece is brought into a position in which the second workpiece is arranged or aligned opposite a workpiece holding device, such as a clamping system, of the machining centre,
moving the transport vehicle into a position, in particular into a transfer or machining position, within the machining area, in which machining of the second workpiece by means of the machining unit is possible,
transferring the second workpiece to be machined from the holding device to the clamping system of the machining centre,
machining the second workpiece clamped by means of the clamping system by means of the machining unit,
transferring the second machined workpiece from the clamping system to the holding device,
moving the transport vehicle, which has received the second machined workpiece and, if applicable, the third workpiece, to a position outside the machining centre,
unloading the second machined workpiece from the transport vehicle.

Corresponding loading and unloading processes of workpieces can be carried out, as described, by means of a corresponding handling device.

The invention is explained again below on the basis of exemplary embodiments with reference to the drawings, in which:

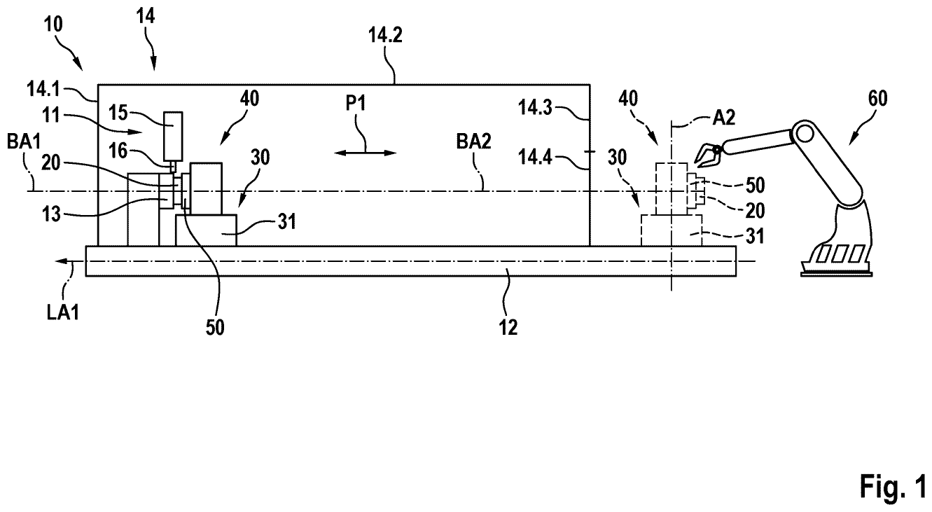

FIG. 1 is a schematic diagram of a machining centre for machining a workpiece according to an exemplary embodiment;

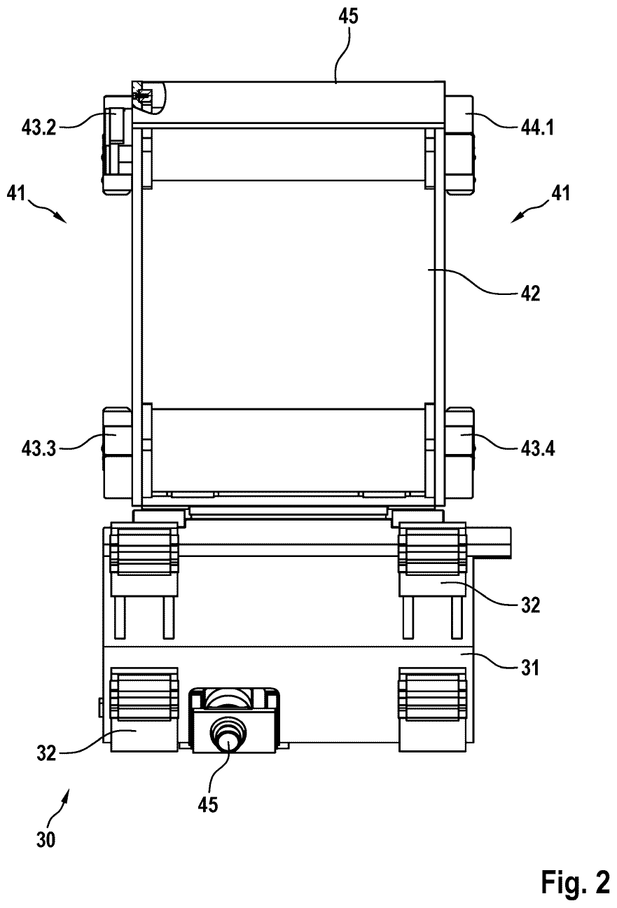

FIGS. 2-4 each show a schematic diagram of a transport vehicle according to an exemplary embodiment;

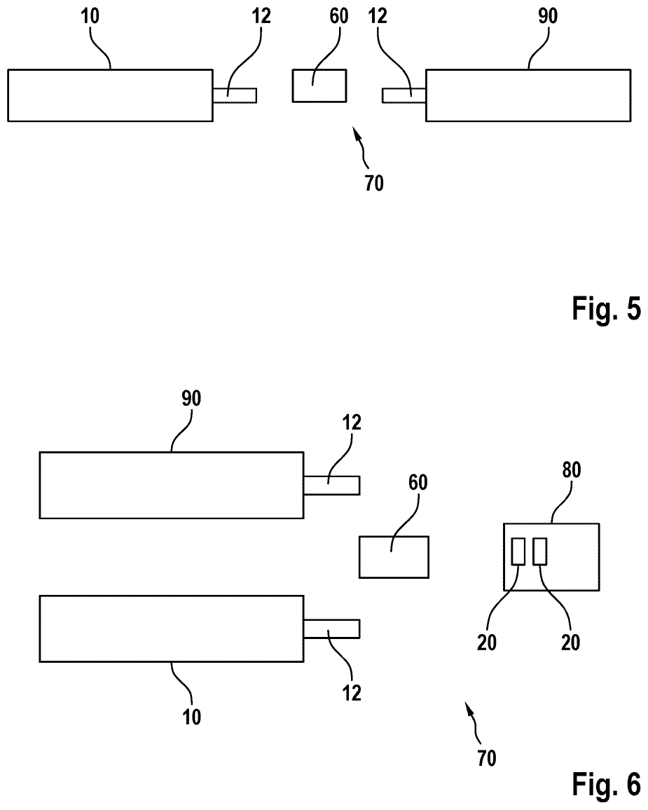

FIGS. 5, 6 each show a schematic diagram of a processing arrangement according to an exemplary embodiment, and

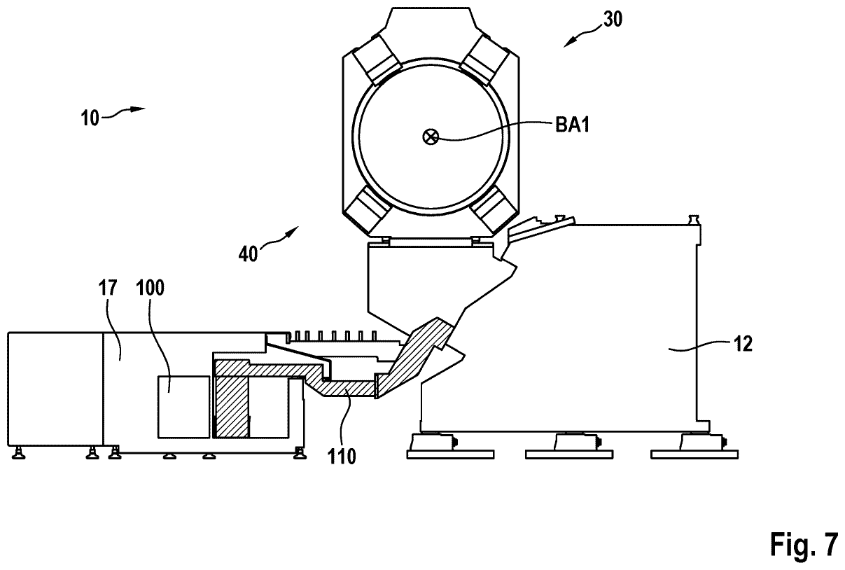

FIG. 7 shows a schematic diagram of a machining centre according to a further exemplary embodiment.

FIG. 1 shows a schematic diagram of a machining centre 10 for machining a workpiece 20 according to an exemplary embodiment in a side view.

The machining centre 10 is configured for machining a workpiece 20. A metal-cutting machining of a workpiece 20 can be understood to mean, for example, a drilling machining and/or a turning machining and/or a milling machining of a workpiece 20. The machining centre 10 may thus be configured as a drilling centre, a turning centre, or a milling centre, or a combined drilling and/or turning and/or milling centre.

The workpiece 20 or a workpiece 20 that can be machined by means of the machining centre 10 is typically a metallic workpiece 20, i.e., for example, a workpiece 20 made of an iron-based metallic material. The workpiece 20 or a workpiece that can be machined by means of the machining centre 10 can have a rotationally symmetrical shape or basic shape. The workpiece can thus be, for example, at least partially, optionally completely, disk-shaped, annular disk-shaped, cylindrical or hollow cylindrical.

The machining centre 10 comprises a machining area 11, in which the machining of the workpiece 20 takes place. The machining area 11, which may also be referred to as a machining chamber, contains a machine bed 12 or machine frame as well as a clamping system 13, e.g. in the form of a chuck or a zero-point clamping system, for clamping a workpiece 20 to be machined.

As can be seen, the machining area 11 can be delimited or defined by a housing structure 14 of the machining centre 10. The housing structure 14 is formed by one or more housing structure elements 14.1-14.4. The housing structural elements 14.1-14.4 can form walls that delimit the machining area 11. At least one housing structural element 14.1-14.4 can be mounted movably relative to at least one other housing structural element 14.1-14.4 in a degree of freedom of movement, i.e. e.g. in a sliding and/or pivoting degree of freedom of movement, in order to be moved into at least one open position, in which an access possibility into the machining area 11 is provided, and/or in order to be moved into at least one closed position, in which no access possibility into the machining area 11 is provided.

In the exemplary embodiment according to FIG. 1, by way of example, at least the housing structure element 14.4 is movably mounted in a corresponding open and closed position. The housing structural element 14.4 can thus form a door, which can be moved into a corresponding open and closed position.

Arranged in the machining area 11 is a machining unit 15, which comprises a machining tool 16 for machining a workpiece 20. The machining tool 16 may be, for example, a drilling tool and/or a turning tool and/or a milling tool. Consequently, the machining unit 15 can be designed as a drilling unit, a turning unit or a milling unit or a combined drilling and/or turning and/or milling unit. Depending on the specific embodiment, the machining unit 15 and/or the machining tool 15 can be mounted so as to be movable in at least one translational and/or rotational degree of freedom of movement, e.g. relative to a horizontal and/or vertical spatial axis, e.g. in order to be able to machine a workpiece 20 to be machined on different sections and/or in different orientations. The machining centre 10 can thus enable complete machining of a workpiece 20 to be machined.

The machining tool 16 is in particular configured to machine a workpiece 20 to be machined in at least one machining axis BA1 or relative to at least one machining axis BA1. FIG. 1 shows that the machining axis BA1 can be a horizontally aligned axis or that the machining axis BA1 can be aligned parallel to a longitudinal axis LA1 of the machine bed 12 or machine frame. For a workpiece 20 that has a rotational axis or a central axis and is to be machined, it is typically the case that it is typically arranged coaxially with respect to the machining axis BA1 or parallel to the machining axis BA1 during machining by means of the machining unit 15.

It can also be seen from FIG. 1 that the machine bed 12 or machine frame is designed to be elongated in the longitudinal direction defined by the longitudinal axis LA1, so that the machine bed 12 or machine frame extends only inside the machining area 11, but also outside the machining area 11. As can be seen, the machine bed 12 or machine frame extends into an area outside the housing structure 14. The machine bed 12 or machine frame therefore has sections both inside and outside the housing structure 14.

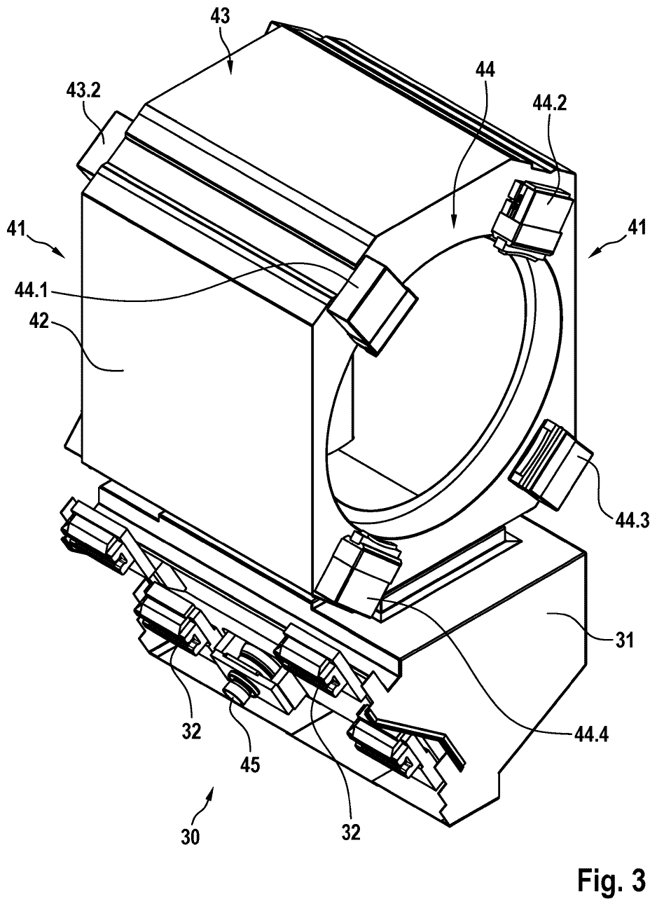

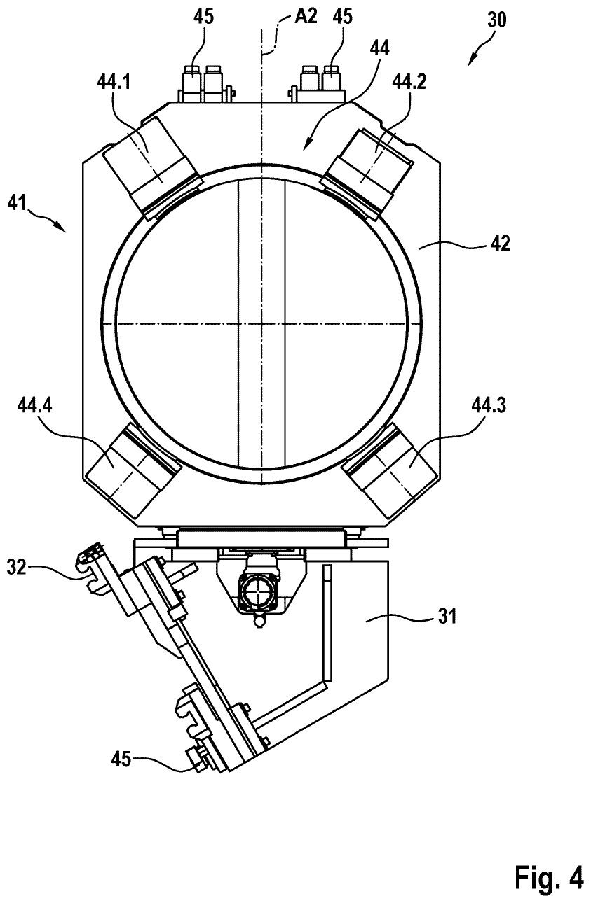

The machining centre 10 further comprises a transport vehicle 30. The transport vehicle 30 shown by way of example in FIG. 2-4 in various views, namely a side view (FIG. 2), a perspective view (FIG. 3) and a front view (FIG. 4), is designed with or comprises a holding device 40 for receiving at least two workpieces 20. The transport vehicle 30 can thus comprise a base(body) structure 31, e.g. in the form of a chassis or a chassis, on which the holding device 40 for receiving at least two workpieces 20 is arranged or formed.

The holding device 40 is therefore basically configured to receive at least two workpieces 20 these may be unmachined workpieces 20 and/or workpieces 20 that have been machined at least in sections. However, this does not mean that the holding device 40 necessarily always receives at least two workpieces 20 during operation of the machining centre 10; the holding device 40 is only configured for this purpose in principle.

A holding fixture of a respective workpiece 20 by means of the holding device 40 can be understood as a direct or indirect holding fixture of the respective workpiece 20. Corresponding active sections of the holding device 40 configured to receive at least one workpiece can thus act directly or indirectly on a respective workpiece 20 in order to hold the respective workpiece 20 directly or indirectly. The holding device 40 can thus be configured to receive at least one workpiece 20 directly; the respective workpiece 20 is thus received by means of the holding device 40 without the interposition of a device system 50 that supports the workpiece 20, such as, for example, a clamping or tensioning system. Corresponding operative portions of the holding device 40 can engage the workpiece 20 here in order to receive the latter. Alternatively or additionally, the holding device 40 can be configured to indirectly receive at least one workpiece 20, and the respective workpiece 20 is therefore received by means of the holding device 40 with the interposition of a device system 50 that supports the workpiece 20, such as a clamping or tensioning system. Corresponding operative portions of the holding device 40 may engage the device system 50 here to receive it. A corresponding device system 50 may be embodied as or comprise, e.g., a chuck, in particular a power chuck, or a zero-point clamping system.

A holder of a respective workpiece 20 by means of the holding device 40 typically includes a workpiece 20 to be machined being received or held by means of the holding device 40 in such a way that it can be transferred from the holding device 40 to the clamping system 13 or taken over by the latter within the machining area 11. Similarly, holding the respective workpiece 20 to be machined or machined by means of the holding device 40 typically means that a machined workpiece 20 can be received or held by means of the holding device 40 in such a way that it can be transferred from the clamping system 13 to the holding device 40 or taken over by the latter within the machining area 11.

In principle, it is also conceivable that a workpiece 20 picked up by means of the holding device 40 can be machined as intended by means of the machining unit 15 within the machining area 11; in this case, the workpiece 20 does not have to be transferred to or taken over by the clamping system 13.

The holding device 40 is thus configured to receive or hold a respective workpiece 20 in a specific orientation and/or position, which corresponds to an orientation and/or position in which the respective workpiece 20 can be transferred to the clamping system 13 or in which the respective workpiece 20 can be machined or machined by means of the machining unit 15. Thus, the holding device 40 can be specifically configured, for example, to receive a respective workpiece 20 in an orientation and/or position in which the rotational or central axis of the workpiece 20 is arranged coaxially with respect to the machining axis BA1 or parallel to the machining axis BA1. The receiving or holding of a respective workpiece 20 in such an orientation and/or position can enable a transfer of the workpiece 20 to the clamping system 13 or a machining of the workpiece 20 by means of the machining unit 15.

As indicated in FIG. 1 by the double arrow P1, the transport vehicle 30, in addition to the holding device 40, is movably mounted in a translational degree of freedom of movement between at least a first position within the machining centre 10, i.e. within the machining area 11, and at least a second position outside the machining centre 10. The transport vehicle 30 can thus be moved translationally along a movement axis BA2 into at least a first position within the machining centre 10, i.e. within the machining area 11, and into at least a second position outside the machining centre 10. It can be seen from FIG. 1 that the movement axis BA2 of the transport vehicle 30 can be arranged or aligned coaxially with respect to the processing axis BA1 or parallel to the processing axis BA1.

It can further be seen from FIG. 1 that the at least one first position is located within the housing structure 14, whereas the at least one second position is located outside the housing structure 14. If the machining centre 10 comprises a housing structure 14 with a housing structure element 14.4 movably mounted between an open and a closed position, as explained, it may be necessary to move the movably mounted housing structure element 14.4 into the open position in order to move the transport vehicle 30 from the first position into the second position, or vice versa.

In FIG. 1, the transport vehicle 30 is shown in both a first and a second position for illustrative purposes; this does not mean that the machining centre 10 must have two transport vehicles 30. FIG. 1 shows that the at least one first position can correspond to a transfer position or a machining position of a workpiece 20 received or held by means of the holding device 40. A workpiece 20 received by means of the holding device 40 can therefore be arranged or aligned within the machining area 11 in the at least one first position in such a way that it is in a transfer position in which it can be transferred to the clamping system 13 (the machining of the workpiece 20 by means of the machining unit 15 or the machining tool 16 therefore takes place in the clamped state by means of the clamping system 13). Alternatively, a workpiece 40 received or held by means of the holding device 40 can be arranged or aligned in the at least one first position within the machining area 11 in such a way that it is located in a machining position in which it can be machined by means of the machining unit 15 or the machining tool 16.

Due to the possibility that the transport vehicle 30 can be moved into at least one corresponding second position outside the machining centre 10, both a particularly efficient pick-up or loading of a workpiece 20 to be machined onto the holding device 40 and a particularly efficient removal or unloading of a workpiece 20 machined from the holding device 40 can be realized outside the machining centre 10, i.e. in particular outside the machining area 11. Corresponding pick-up or loading as well as corresponding removal or unloading operations can be carried out by means of a handling device 60, such as a handling robot, which can be assigned or is assigned to the machining centre 10.

The fact that the transport vehicle 30 and/or the holding device 40 is mounted so as to be movable in a rotational degree of freedom of movement about an axis of rotation A 2 oriented at an angle or at a right angle to the axis of movement BA2 of the transport vehicle 30 contributes to a particularly efficient removal or unloading of workpieces 20. The transport vehicle 30 and/or the holding device 40 are therefore mounted so as to be movable individually or together in a rotational degree of freedom of movement. By means of corresponding rotational or rotational movements of the transport vehicle 30 and/or the holding device 40 in the rotational degree of freedom of movement, receiving or removal processes of workpieces 20 can be carried out even more efficiently, in particular because a workpiece 20 to be received on one side of the holding device 40 and to be machined can be brought by corresponding rotation of the transport vehicle 30 and/or the holding device 40 into an orientation and/or position in which it can be machined after moving the transport vehicle 30 into the first position, i.e. in particular into a corresponding transfer or machining position, and/or because a workpiece 20 received on another side of the holding device 40 and already machined can be brought by corresponding rotation of the transport vehicle 30 and/or the holding device 40 into an orientation and/or position in which it can be removed from the holding device 40 after moving the transport vehicle 30 into the second position, e.g. by means of the handling device 60.

In principle, by appropriately rotating the transport vehicle 30 and/or the holding device 40 in the rotational degree of freedom of movement, each receiving region of the holding device 40 can be brought into an orientation in which it is arranged opposite a workpiece holding device, e.g. the clamping system 13, of the machining centre 10. Based on this, a workpiece 20 received or held in the receiving region of the holding device 40 can be moved into a corresponding transfer or processing position by moving the transport vehicle 30 into the first position.

In the exemplary embodiments shown in the Fig., a configuration of the transport vehicle 30 is shown by way of example, in which only the holding device 40 is movably mounted in the rotational degree of freedom of movement. With regard to the rotational degree of freedom of movement of the holding device 40, this allows rotational movements of the holding device 40 relative to the transport vehicle 30, i.e. in particular relative to the base(body)structure 31 of the transport vehicle 30. The holding device 40 can thus be moved relative to the base(body)structure 31 and in principle independently thereof in the at least one rotational degree of freedom of movement. For this purpose, the transport vehicle 30, i.e. in particular the base(body)structure 31, can comprise one or more rotary bearings (not shown), via which the holding device 40 is mounted rotatable relative to the base(body)structure 31.

As can be seen, for example, from FIGS. 2-4, the holding device 40 can have at least two receiving regions 41 for in each case one workpiece 20, wherein at least one receiving region 41 typically being arranged and/or aligned in such a way that a workpiece 20 can be received or received in such a way that it can be moved into a corresponding transfer or processing position when the transport vehicle 30 is moved into the at least one first position. Each receiving region 41 can have or define at least one plane or surface on which at least one workpiece can be received and held stably.

The receiving regions 41 of the holding device 40 are arranged or formed on different sides of the holding device 40; in the exemplary embodiments shown in the figures, the receiving regions 41 are arranged or formed on opposite sides of the holding device 40.

It has been mentioned that by corresponding rotation of the transport vehicle 30 and/or the holding device 40 in the rotational degree of freedom of movement, each receiving region 41 can in principle be brought into an orientation in which it is arranged opposite a workpiece holding device, such as the clamping system 13, of the machining centre 10. The transport vehicle 30 and/or the holding device 40 can thus be movably mounted in the rotational degree of freedom of movement into a first position in which a first workpiece 20, which is received by means of the holding device 40 and can be received in a first receiving region 41 of the holding device 40, is arranged or aligned opposite a workpiece holding device of the machining centre 10. Alternatively or additionally, the transport vehicle 30 and/or the holding device 40 can be movably mounted in the rotational degree of freedom of movement into a second position in which a second workpiece 20, which is received by means of the holding device 40 and can be received in a second receiving region 41 of the holding device 40, is arranged or aligned opposite the workpiece holding device of the machining centre 10.

The first position of the transport vehicle 30 and/or the holding device 40 can be a position rotated by 180° with respect to the axis of rotation A2 relative to the second position, and vice versa.

It can be seen from FIGS. 2-4 that the holding device 40 has a receiving frame 42, in particular a cage-like or basket-like receiving frame, or a receiving frame, in particular a cage-like or basket-like receiving frame. The receiving frame 42 or the receiving frame can be formed by one or more frame or frame elements, which are connected to one another in one or more spatial directions or spatial planes, forming the receiving frame 42 or receiving frame. Corresponding receiving regions 41 for workpieces 20 are arranged or formed on the receiving frame 42 or the receiving frame.

A first holding device 43 for holding a first workpiece 20 or for holding a device system that supports a first workpiece 20, in particular a clamping or tensioning system, and at least one second holding device 44 for holding a second workpiece 20 or for holding a device system that supports a second workpiece 20, in particular a clamping or tensioning system, are arranged or configured on the receiving frame 42 or the receiving frame. The holding devices 43, 44 are assigned to respective receiving regions 41 of the holding device 40 and are accordingly arranged or formed on different, i.e. in particular opposite, sides of the receiving frame 42 or of the receiving frame.

It can also be seen from FIGS. 2-4 that the first holding device 43 and the second holding device 44 each have a plurality of holding elements 43.1.-43.4, 44.1.-44.4, which can each be transferred into at least one holding position, in which a holding force holding a device system supporting a workpiece 20 or a workpiece 20 is formed, and into at least one non-holding position, in which no holding force holding a device system supporting a workpiece 20 or a workpiece 20 is formed. Respective mounting elements 43.1-43.4, 44.1-44.4 are thus movably arranged or formed on the receiving frame 42. The holding elements 43.1-43.4, 44.1-44.4 can therefore be the active sections of the holding device 40 mentioned above.

The holding elements 43.1-43.4, 44.1-44.4 can each be designed as clamping or clamping jaws, in particular as clamping or clamping jaws acting axially and/or radially with respect to the machining axis or a central axis of the respective workpiece 20 in the respective holding position. It can also be seen from FIGS. 2-4 that the holding elements 43.1-43.4, 44.1-44.4 can be arranged or formed uniformly distributed in the circumferential direction with respect to the machining axis or a central axis of the respective workpiece 20.

In order to set the transport vehicle 30 and/or the holding device 40 in corresponding translational and/or rotational movements, the machining centre 10 may comprise a provision device 100 for providing energy for generating a driving force that sets the transport vehicle 30 and/or the holding device 40 in translational and/or rotational movements. In this case, the drive force that sets the transport vehicle 30 and/or the holding device 40 into corresponding translational and/or rotational movements can be generated via a drive unit, e.g., a motor drive unit of the transport vehicle 30 and/or the holding device 40, which provides the drive medium to the providing device 100. The drive medium may be an energy carrier, e.g. in the form of electrical energy, hydraulic energy or pneumatic energy. The drive unit of the transport vehicle 30 and/or the holding device 40 can therefore be embodied as, or comprise, an electrical, electromechanical, hydraulic or pneumatic drive unit, for example.

It can be seen from the exemplary embodiment according to FIG. 7, which shows a partially sectioned axial view of the machining centre 100, that the supply device 100 can be arranged in a part of the machining centre 10 that is separate from a machine bed 12 or machine frame and can be connected to the machine bed 12 or machine frame and further to the transport vehicle 30 or the holding device 40 via a carrier 110 for supply lines, e.g. in the form of a so-called cable drag or an energy guiding chain for supply lines. In the exemplary embodiment, the provisioning device 100 is arranged, by way of example, in a pedestal-like or pedestal-shaped operating area 17 of the machining centre 10 that can be walked on by a user.

The energy carrier provided via the provision device 100 can therefore be provided at an output of the provision device 100 and transmitted by means of supply lines received in a corresponding carrier 110 to an output of the provision device 100 at an input of the transport vehicle 30 and/or of the holding device 40. The supply device 100 can thus have an output, e.g. in the form of an output connection for a respective energy carrier, via which an energy carrier can be transmitted to the transport vehicle 30 and/or the holding device 40 via corresponding supply lines. Accordingly, the transport vehicle 30 and/or the holding device 40 can have an input, e.g. in the form of an input connection for a respective energy carrier, via which the energy carrier can be supplied to the transport vehicle 30 and/or the holding device 40. A corresponding output and a corresponding input can therefore, as mentioned, be connected to one another via one or more line connections or supply lines, such as cables, hoses, pipes, etc., accommodated in a corresponding carrier 110.

Of course, as an alternative or in addition to the at least one input on the part of the transport vehicle 30 and/or the holding device 40, a control interface can also be provided, via which control information or signals, for example for controlling the operation of the holding devices 43, 44, can be transmitted to the transport vehicle 30 or the holding device 40. Data cables for transmitting corresponding control information may also be accommodated in the carrier 110.

The energy for setting the transport vehicle 30 and/or the holding device 40 in corresponding translational and/or rotational movements can therefore be provided via a providing device 100 of the machining centre 10; the transport vehicle 30 and/or the holding device 40 therefore does not have to have its own energy supply, which is thus independent of the machining centre 10, as the energy supply that is required or given in any case for the operation of the machining centre 10 can also be used for the energy supply of the transport vehicle 30 and/or the holding device 40. In particular, the energy supply required in any case for the operation of the machining centre 10 can be used to generate corresponding driving forces, via which the transport vehicle 30 and/or the holding device 40 can be set into corresponding translational and/or rotational movements. Corresponding drive forces can specifically be generated, for example, via motorized drive units of the transport vehicle 30 and/or the holding device 40, which are or will be operated with the energy carriers provided by the providing device 100.

In an analogous manner, the energy required for the movements of the holding elements 43.1 43.4, 44.1-44.4 into the respective holding position and non-holder positions, and thus the energy supply to the respective holding devices 43, 44, can take place via the energy supply that is required or given anyway for the operation of the machining centre 10.

In all exemplary embodiments, the specific movable mounting of the transport vehicle 30 can be realized via storage devices or elements. The transport vehicle 30 can therefore be designed as or comprise a carriage or trolley guided on a transport track, in particular a rail, via at least one bearing element, in particular a sliding, ball or roller bearing element. In principle, linear drives or units, such as, for example, sliding drives or units, spindle drives or units, rack and pinion drives or units, etc., are suitable for movably supporting the transport vehicle 30 in the translational degree of freedom of movement. Reference numeral 45 in FIGS. 2, 3 shows, purely by way of example, a pinion 45 or gearwheel of a conceivable rack-and-pinion drive or rack-and-pinion unit. The transport track arranged or formed in the exemplary embodiments on or in the machine bed 12 or machine frame can thus define the translational degree of freedom of movement in which the transport vehicle 30, as described, is movably mounted in the at least one first and in the at least one second position. Both on the part of the transport vehicle 30 and on the part of the transport track, which, as mentioned, can be formed by the machine bed 12 or machine frame, cooperating guide elements (cf. the guide elements 32 of the transport vehicle 30 shown by way of example in FIG. 34) can be present, for example in a form-fitting manner, which enable a stably guided movement of the transport vehicle 30 in the translational degree of freedom of movement. It has been mentioned that workpieces 20 can be picked up on the holding device 40 and/or removed from the holding device 40 by means of handling devices 60. The machining centre 10 can thus comprise at least one handling device 60, in particular implemented by an industrial robot or comprising such a handling device, which is configured to load the transport vehicle 30, in particular the transport vehicle 30 moved into a loading position outside the machining centre 10, with at least one workpiece 20 and/or to unload at least one workpiece 20 from the transport vehicle 30, in particular from the transport vehicle 30 moved into an unloading position outside the machining centre 10.

The at least one handling device 60 can be configured, in particular, for transferring a workpiece 20, in particular a workpiece 20 that has not yet been machined or a workpiece 20 that has been machined at least in sections, from the machining centre 10 to a process station, such as a set-up station or a conversion station, and/or to a further machining centre (cf. FIGS. 5, 6).

The machining centre 10 may comprise a hardware-and/or software-implemented control device (not shown), which is configured to control the operation of the machining centre 10. In particular, the control device is configured to control corresponding movements of the transport vehicle 30 and/or the holding device 40 as well as corresponding movements of the holding device elements 43.1-43.4, 44.1-44.4 in a coordinated manner in order to enable, in particular in an automated or automated manner, e.g. a proper loading of the holding device 40 with at least one workpiece 20 to be machined, a proper transfer of a workpiece 20 to be machined from the holding device 40 to the clamping system 13, a proper machining of at least one workpiece 20 by means of the machining unit 15, a proper transfer of a workpiece 20 machined to the holding device 40, and a proper unloading of at least one workpiece 20 machined from the holding device 40.

FIGS. 5, 6 show, by way of example, two machining arrangements 70 for machining at least one workpiece 20 in plan views. As can be seen, the processing arrangements 70 each comprise at least one first machining centre 10, at least one process station 80, such as a set-up station or a conversion station, and/or at least one further processing centre 90 and at least one handling device 60. The at least one handling device 60 is configured, in particular, for transferring a workpiece 20, in particular a workpiece 20 that has not yet been machined or a workpiece 20 that has been machined at least in sections, from the first machining centre 10 to the at least one further machining centre 90 and/or to the at least one process station 80, or vice versa.

The processing arrangement 70 can be configured in various ways with regard to the arrangement of the units associated with it, i.e. the at least one first machining centre 10, the at least one further processing centre 90 and/or the at least one process station 80. For example, as FIG. 5 shows, the first machining centre 10 and the at least one further machining centre 90 may be arranged connected in series, or, as FIG. 6 shows, the first machining centre 10, the at least one further machining centre 90, and the process station 80 may be arranged connected at an angle to one another, in particular parallel to one another. In all cases, the at least one handling device 60 can be arranged between the units of the respective processing arrangement 70, e.g. to enable a workpiece 20 to be transferred from a first machining centre 10 to a further processing centre 90 and/or to a process station 80.

The machining centre 10 or the machining arrangements 70 shown in the Fig. can be used to implement a method for operating at least one machining centre 10. The method comprises at least the following steps: Moving the transport vehicle 30, which has received at least one workpiece 20 to be machined, into a position within the machining area 11 of a machining centre 10 (first position), in particular into a corresponding transfer or machining position, and moving the transport vehicle 30, which has received at least one workpiece 20 machined in the machining area 11 of the machining centre 10, into a position outside the machining area 11 (second position).

The method may further comprise a step of moving the transport vehicle 30 or the holding device 40 in the rotational degree of freedom of movement outside or inside the machining area 11. In this way, for example, loading and unloading processes of the holding device 40 can be realized with at least one workpiece 20.

In a specific embodiment, the method may comprise the following steps:
moving the transport vehicle 30, which has received at least one workpiece 20 to be machined, into a position, in particular into a transfer or machining position, in which machining of the workpiece 20 by means of the machining unit 15 is possible, within the machining area 11,
transferring the at least one workpiece 20 from the holding device 40 to a clamping system 13 of the machining centre 10,
machining the at least one workpiece 20 clamped by means of the clamping system 13 within the machining area 11 by means of the machining unit 15,
transferring the at least one machined workpiece 20 from the clamping system 13 of the machining centre to the holding device 40,
moving the transport vehicle 30, which has received the at least one machined workpiece 20, to a position outside the machining centre 10,
unloading the at least one machined workpiece 20 from the transport vehicle 30.

The method may further comprise the steps of:
rotating the transport vehicle 30 and/or the holding device 40 in the rotational degree of freedom of movement,
loading the holding device 40 with a second workpiece 20 to be machined,
moving the transport vehicle 30, which has received the second workpiece 20 to be machined, into a position within the machining area 11, in particular into a transfer or machining position, in which machining of the second workpiece 20 by means of the machining unit 15 is possible,
transferring the at least one second workpiece 20 to be machined from the holding device 40 to a clamping system 13 of the machining centre 10,
machining the at least one second workpiece 20 clamped by means of the clamping system 13 within the machining area 11 by means of the machining unit 15,
transferring the at least one second machined workpiece 20 from the clamping system 13 of the machining centre to the holding device 40,
moving the transport vehicle 30, which has received the at least one second machined workpiece 20, to a position outside the machining centre 10,
unloading of at least one second machined workpiece 20 from transport vehicle 30.

In a further specific embodiment, the method may comprise the following steps:
moving the transport vehicle 30, which has received two workpieces 20 to be machined mechanically, into a position, in particular into a transfer or machining position, in which machining of a first workpiece 20 by means of the machining unit 15 is possible, within the machining area 11,
transferring the first workpiece 20 to be machined from the holding device 40 to a clamping system 13 of the machining centre 10 in the machining area 11,
machining the first workpiece 20 clamped by means of the clamping system 13 by means of the machining unit 15,
transferring the first machined workpiece 20 from the clamping system 13 of the machining centre to the holding device 40,
moving the transport vehicle 30, which has received the first machined workpiece 20 and the second (still unmachined) workpiece 20, to a position outside the machining centre 10,
unloading the first machined workpiece 20 from the transport vehicle 30,
if necessary, loading the holding device 40 with a third workpiece 40 to be machined at a free receiving region of the holding device 40, e.g. at which the first workpiece 20 was previously received,
rotating the transport vehicle 30 and/or the holding device 40 in the rotational degree of freedom of movement in such a way that the second workpiece 20 is brought into a position in which the second workpiece 20 is arranged or aligned opposite a workpiece holding device, such as the clamping system 13, of the machining centre 10,
moving the transport vehicle 30 into a position, in particular into a transfer or machining position, within the machining area 11, in which machining of the second workpiece 20 by means of the machining unit 15 is possible,
transferring the second workpiece 20 to be machined from the holding device 40 to the clamping system 13 of the machining centre 10,
machining the second workpiece 20 clamped by means of the clamping system 13 by means of the machining unit 15,
transferring the second machined workpiece 20 from the clamping system 13 to the holding device 40,
moving the transport vehicle 30, which has received the second machined workpiece 20 and optionally the third workpiece 20, to a position outside the machining centre 10,
unloading the second machined workpiece 20 from the transport vehicle 30.

Corresponding loading and unloading processes of workpieces 20 can be carried out as described, in particular in an automated or automated manner, by means of a corresponding handling device 60.

Individual, multiple, or all features disclosed in connection with a particular exemplary embodiment may be combined with individual, multiple, or all features of at least one other exemplary embodiment.

1. A machining centerfor machining a workpiece, comprising a machining unit arranged in a machining area of the machining center, which comprises a machining tool for machining a workpiece relative to a machining axis, wherein the machining center comprises:
a transport vehicle with a holding device for receiving at least two workpieces, wherein
the transport vehicle is movably mounted in a translational degree of freedom of movement at least between a first position within the machining center,
and a second position outside the machining center, and wherein
the transport vehicle and/or the holding device is mounted movably in a rotational degree of freedom of movement.

2. The machining center according to claim 1, wherein the transport vehicle and/or the holding device is mounted movably in a rotational degree of freedom of movement between a first position, in which a first workpiece received by means of the holding device is arranged or aligned opposite a workpiece holding device of the machining center, and a second position, in which a second workpiece received by means of the holding device is arranged or aligned opposite the workpiece holding device of the machining center.

3. The machining center according to claim 2, wherein the first position is a position relative to the second position.

4. Machining center according to claim 1, wherein the holding device has a receiving frame, on which is arranged or formed:
a first holding device for holding a first workpiece or for holding a device system supporting a first workpiece, and
a second holding device for holding a second workpiece or for holding a device system supporting a second workpiece.

5. Machining center according to claim 4, wherein the first holding device has one or more first holding elements, which can be transferred into at least one holding position, in which a holding force holding a device system supporting a first workpiece or a first workpiece is formed, and into at least one non-holding position, in which no holding force holding a device system supporting a first workpiece or a first workpiece is formed, and/or wherein the second holding device has one or more second holding elements, which can be transferred into at least one holding position, in which a holding force holding a second workpiece or a second workpiece-bearing device system is formed, and into at least one non-holding position, in which no holding force holding a second workpiece or a second workpiece-bearing device system is formed.

6. The machining center according to claim 5, wherein one or more first holding elements are designed as clamping or clamping jaw centeracting axially and/or radially with respect to the machining axis in the respective holding position, and/or
the one or more second holding elements are designed as clamping or clamping jaws,-partiet acting axially and/or radially with respect to the machining axis in the respective holding position.

7. The machining centeraccording to claim 5, wherein the one or more first support members and/or the one or more second support members are arranged or formed circumferentially distributed with respect to the machining axis.

8. The machini center according to claim 1, comprising a drive unit for generating a drive force that sets the transport vehicle and/or the holding device in motion, wherein the drive force that sets the transport vehicle and/or the holding device in motion can be generated via a drive medium provided to the drive unit by a supply device of the machining center.

9. The machining centeraccording to claim 8, wherein the drive medium can be provided or is provided via an output of the machining Kre-center communicating with an input of the transport vehicle.

10. The machining centerof claim 8, wherein the drive unit is configured as, or comprises, an electrical, electromechanical, hydraulic, or pneumatic drive unit.

11. The machining according to claim 1, wherein the transport vehicle is configured as a carriage or carriage guided on a transport track; via at least one bearing device or at least one bearing element or comprises such a carriage or carriage.

12. The machine center according to claim 1, wherein the first degree of freedom of movement comprises movement along the machining axis or an axis parallel thereto.

13. The machining center according to claim 1, further comprising a handling device for loading the transport vehicle with at least one workpiece and/or for unloading at least one workpiece from the transport vehicle
moved into an unloading position outside the machining center.

14. A machining assembly for machining a workpiece, comprising:
a first machining center, which is a machining centeraccording to claim 1,
at least one further machining center for machining a workpiece and/or
at least one process station, and
at least one handling device.

15. A method for operating at least one machining center according to claim 1, comprising the following steps:
moving the transport vehicle, which has received at least one workpiece to be machined, into a position within the machining area in which machining of the workpiece by means of the machining unit is possible,
moving the transport vehicle, which has received at least one workpiece machined in the machining area of the machining center, to a position outside the machining area.
